(19) United States
(12) Patent Application Publication
(10) Pub. No.: US 2024/0426678 A1
(43) Pub. Date: Dec. 26, 2024

(54) Temperature Measuring Device for Non-Invasive Temperature Measurements, Calibration Method, and Computer Program Product

(71) Applicant: Siemens Aktiengesellschaft, Muenchen (DE)

(72) Inventors: Stefan VON DOSKY, Karlsruhe (DE); Markus HILSENDEGEN, Karlsruhe (DE); Thomas BIERWEILER, Stutensee (DE); Wolfgang ENS, Linkenheim (DE); Valentin RIGONI, Wintershouse (FR); Tim SCHERER, Karlsruhe (DE)

(21) Appl. No.: 18/685,415

(22) PCT Filed: Jul. 4, 2022
(86) PCT No.: PCT/EP2022/068427

§ 371 Date: Feb. 21, 2024

(30) Foreign Application Priority Data
Aug. 24, 2021 (DE) 10 2021 209 278.0

(51) Int. Cl. G01K 13/02; G01K 1/143; G01K 1/18; G01K 15/00

(52) U.S. Cl. CPC G01K 13/026; G01K 1/143; G01K 1/18; G01K 15/005

(57) ABSTRACT

A method for calibrating a temperature measuring device, a computer program product for simulating an operating behavior of the temperature measuring device and a temperature measuring device for non-invasively measuring a temperature of a medium in a tube, wherein the temperature measuring device includes first and second temperature sensors that are accommodated in a sleeve that has a closure for contacting a wall of the tube.

### CROSS-REFERENCE TO RELATED APPLICATIONS

This is a U.S. national stage of application No. PCT/EP2022/068427 filed 4 Jul. 2022. Priority is claimed on German Application No. 10 2021 209 278.0 filed 24 Aug. 2021, the content of which is incorporated herein by reference in its entirety.

### BACKGROUND OF THE INVENTION

### 1. Field of the Invention

The invention relates to a temperature measuring device for non-invasively measuring a temperature, a method for calibrating a temperature measuring device, and a computer program product.

### 2. Description of the Related Art

WO 2015/099933 A1 discloses a temperature measuring device for non-invasively measuring a temperature, which can be fastened to a pipe. The temperature measuring device has two temperature sensors that are designed as resistance thermometers and that are attached to a basic structure on the pipe. The temperature sensors are accommodated in a sensor tube that is open at one end facing the pipe.

WO 2015/135739 A1 discloses a measurement system, which serves to measure a temperature of a fluid in a pipe. The measurement system comprises two temperature sensors, a first of which is in thermal contact with the pipe via a coupling body. The second temperature sensor is thermally coupled to the first temperature sensor via a further coupling body. The temperature sensors have a platinum measuring resistor.

WO 2019/063519 A1 discloses a temperature measuring device, with which a temperature of a fluid in a pipe can be measured. The temperature measuring device has a reference sensor and a measurement sensor. These are arranged, in relation to the pipe, in different radial positions and are surrounded by an insulation layer.

In a plurality of applications, such as process automation, there is an increasing need for temperature measurement technology to control technical processes. In particular, there is a need for possibilities for non-invasive temperature measurement of fluids in pipes. There are increasing demands here in terms of measurement accuracy, reliability, possible temperature range and ease of assembly.

### SUMMARY OF THE INVENTION

It is an object of the invention to provide device and method that make it possible to improve non-invasive temperature measurement in at least one of the aspects outlined.

This and other objects and advantages are achieved in accordance with the invention by a temperature measuring device that is configured for non-invasively measuring a temperature of a medium in a pipe. The medium can be a liquid, a gas, a steam or a mixture of these, which is enclosed by the pipe, i.e., a closed cross-section. To this end, the temperature measuring device comprises a first and a second temperature sensor, each of which are suitable for separately detecting a temperature. The first and second temperature sensors are accommodated in a sleeve. Owing to the sleeve, the first and second temperature sensor are protected against environmental influences, in particular thermal influences. In accordance with the invention, the sleeve has a closure, via which the sleeve is closed at one end. The closure is formed to contact a wall of the pipe when the temperature measuring device is in a mounted state. Owing to the contacting, a thermal contact between the sleeve and the wall of the pipe is produced via the closure. The closure of the sleeve contacting the wall allows a defined heat transfer from the pipe to the temperature sensors. The closure has a reduced surface, which abuts the wall in a defined manner, resulting in a heat transfer that is subject to only a minimum of disruptive influences. This, in turn, allows a precise non-invasive temperature measurement of the medium in the pipe.

In an embodiment of the temperature measuring device, the closure of the sleeve is contacted in a mounted state by the first temperature sensor. Here, the first temperature sensor is arranged in thermal contact with the closure of the sleeve. Alternatively, the first temperature sensor is in indirect thermal contact with the closure of the sleeve, where a minimized thermal conduction resistance is present between the first temperature sensor and the closure. Consequently, a change in temperature at the closure of the sleeve can be detected by the first temperature sensor with a reduced delay or with virtually no delay. A change in temperature of the medium in the pipe results in a change in temperature in the wall of the pipe. The measuring principle of the temperature measuring device is based on the temperature of the wall at the physical variable that most quickly follows the temperature of the medium to be measured. As a result, as part of a non-invasive temperature measurement, an increased degree of directness is achieved in the measurement. Accordingly, the contacting of the closure by the first temperature sensor serves to reduce a delay in the measurement of the temperature of the medium.

In addition, within the temperature measuring device, the closure of the sleeve can have a section with a reduced wall thickness. The section with the reduced wall thickness contacts the wall of the pipe in the mounted state. As a result of the reduced wall thickness, the corresponding section of the closure has a reduced thermal conduction resistance. As a result, an improved thermal connection of the first temperature sensor to the wall of the pipe is produced. For example, a rise in temperature of the wall of the pipe in consequence of the section with a reduced wall thickness affects the first temperature sensor more quickly. here, a reduced wall thickness should be understood to mean a wall thickness that is less than a wall thickness of the sleeve, in particular in adjacent regions of the closure of the sleeve. The section with the reduced wall thickness consequently realizes the principle of a thermal bridge or a thermal window between the first temperature sensor and the wall of the pipe. The delay in measuring the temperature of the medium is thus further reduced.

Furthermore, an outer surface of the closure of the sleeve, which in a mounted state of the temperature measuring device abuts the wall of the pipe, can be formed convex or flat. Thermal contacting of the closure of the sleeve with the wall of the pipe occurs via the convex or flat outer surface, which serves as a contact surface. The pipe can itself be formed convex and can have a considerably larger radius than the outer surface of the closure of the sleeve. As a result of the convex or flat shape, a thermal contact between a center region of the outer surface and the wall can always be produced. Because of the ratios on the outer surface and the wall, an edge region of the outer surface, in which the wall is not contacted, is minimized. A complex adjustment of a concave shape of the outer surface to the convex shape of the pipe is therefore unnecessary. Also unnecessary are thermally coupling intermediate layers, for example, made of heat-conducting paste. In particular, a section of the sleeve with a minimized wall thickness can be formed in a center region of the outer surface so that it can be thermally contacted with the wall of the pipe if the outer surface is flat or convex in shape. Here, the convex shape includes both a uniaxially curved outer surface and a synclastic outer surface. Overall, the temperature measuring device can be used on a wide range of pipes without sacrificing the quality of accuracy of measurement.

In a further embodiment of the temperature measuring device, the sleeve is detachably accommodated in a holder that protrudes substantially radially from the pipe. The holder can, in this case, be connected to the pipe by clamps or buckles. Furthermore, the holder can be fastened to the sleeve at axially spaced regions on the pipe. As a result, thermal interference to a region in which the wall of the pipe is thermally contacted by the sleeve is minimized. The holder provides an anchor for the sleeve, from which it can be non-destructively detached. The sleeve is protected by the holder against mechanical influences. Furthermore, the sleeve can be removed from the holder and can be separately inspected, repaired or calibrated. As a result of the holder remaining in the same location, an occurrence of a measurement error due to the temperature measuring device being repositioned is ruled out after remounting. In addition, the ease of maintenance of the temperature measuring device is thus increased, in particular because of the interchangeability of the sleeve with the temperature sensors. Likewise, recalibrations of the temperature sensors that are necessary during operation are simplified. The holder protruding substantially radially from the pipe consequently serves to simplify the calibration of the temperature measuring device, and thus to ensure long-term precise operation.

Furthermore, a thermal insulator can be accommodated in the sleeve, by which a heat flow between the first and/or second temperature sensor and the sleeve is minimized. Here, the thermal insulator can be a gas, a gas mixture, such as air, a mineral substance such as perlite or mineral wool or aerogel. A heat flow conducted via the sleeve to the first temperature sensor thus reaches the second temperature sensor substantially without scatter loss. In addition, as a result of the thermal insulator, interference from the environment to the temperature sensors is reduced, i.e., an increased measurement accuracy can be attained.

In a further embodiment of the temperature measuring device, the first and second temperature sensors can be fastened to a sensor carrier. The sensor carrier can, in this case, be formed substantially rod-shaped and can also be accommodated in the sleeve. The first and second temperature sensors can be arranged on the sensor carrier radially spaced apart from one another. Accordingly, a heat flow from the first to the second temperature sensors occurs during operation of the temperature measuring device, and can flow via the sensor carrier. Alternatively a thermal coupling can also occur via a thermal coupler, such as a wire, between the first and second temperature sensor, in other words a thermally conductive connection can be produced. Overall, a thermal conduction resistance is defined between the first and second temperature sensors, and using this and measured values of the temperature sensor the temperature of the medium can be determined. The sensor carrier can be produced in a simple manner with increased precision, so that its heat-conducting resistance can be ascertained exactly, and in consequence a precise temperature measurement can be achieved. Furthermore, the sensor carrier can be pressed against the closure of the sleeve by a reset force of an elastic element, such as a spring. As a result, a targeted thermal coupling between the sensor carrier and the sleeve can easily be achieved.

Furthermore, within the temperature measuring device the first and/or second temperature sensors can at one end face away from the pipe, and thus also from the closure, be firmly connected to a measuring transducer connection. In particular, the first and/or second temperature sensors can be formed as a resistance thermometer, in particular a platinum resistance thermometer. The first and/or second temperature sensors are electrically connected via the measuring transducer connection, so that the electrical resistance present in the respective temperature sensor can be determined from measured values of voltage or current strength. Consequently, a measuring transducer of the temperature measuring device can easily be exchanged. This allows separate functional and quality testing of the measuring transducers that are to be attached to the measuring transducer connection to be performed during production. As a result, defective or poor-quality measuring transducers can be identified at an early stage and thus faulty temperature measuring devices can easily be prevented. Replacing the measuring transducer is likewise simplified in this way. As a result, the functional and quality testing can be separated from the rest of the production process, making the production of the claimed temperature measuring device simpler and more economical.

In addition, within the temperature measuring device, the temperature sensors can be connected directly or indirectly to a housing in a section facing away from the pipe. The first and/or second temperature sensor can in this case be formed substantially rod-shaped. A measuring transducer is arranged in the housing, and is coupled to the measuring transducer connection. The housing is here detachably connected to the holder, i.e., can be non-destructively detached, such as via a bayonet lock. The housing with the measuring transducer and the temperature sensors can consequently be detached from the holder as a module and can be immersed at least partially in a calibration bath, in order to perform a recalibration of the temperature measuring device. Likewise, the temperature measuring device can be replaced as a whole. By providing suitable parameters the temperature measuring device can be replaced, as a result of which downtimes can be reduced in an application, such as an automation system.

The objects and advantages in accordance with the invention are likewise achieved by a method for calibrating a temperature measuring device. The temperature measuring device is configured for non-invasively measuring a temperature of a medium in a pipe and to this end comprises a housing with a measuring transducer accommodated therein. A first and a second temperature sensor are connected to the measuring transducer, which in turn are accommodated in a sleeve. The sleeve is connected to the housing. The method comprises a first step, in which the housing together with the sleeve connected thereto is detached from a holder that extends substantially radially away from the pipe. To this end, for example, a bayonet lock on the holder is detachable. The radial direction in which the holder protrudes is here related to the pipe. In a subsequent second step, the sleeve is immersed at least partially in a calibration bath, for example, containing sand, water or oil. As a result, the sleeve is subjected to a defined temperature. A calibration measurement is thus performed on the sleeve. Using the calibration measurement, parameters can in turn be determined for the temperature measuring device. Such parameters can, in the case of temperature sensors formed as platinum resistance thermometers, for example, be coefficients of a Callendar-van-Dusen equation. There follows a third step, in which the measuring transducer is adjusted as a function of the calibration measurement, in other words of the result achieved. To this end, parameters obtained, for example, from the calibration measurement can be specified to the measuring transducer. This can be done by a user input and/or an automatic function. Overall, here, the result of the calibration measurement is transferred to the temperature measuring device. In a subsequent fourth step, the housing with the sleeve attached thereto is again fastened to the holder. To this end, for example, the bayonet lock on the holder can again be reengaged. Owing to the fourth step the temperature measuring device is again ready for operation, i.e., is set up to measure the temperature of the medium in the pipe.

Here, the sleeve of the temperature measuring device has a closure and is closed thereby at one end. In the fourth step, the closure on the sleeve is brought into thermally conductive contact with a wall of the pipe, in which the temperature of the medium located therein is to be measured. In the fourth step, the closure of the sleeve is brought into contact with the wall of the pipe and is substantially held in this position. A defined heat flow to the first temperature sensor is ensured via the closure of the sleeve, and allows the temperature of the medium to be determined precisely. The inventive method can be performed quickly and is subject to only minimal interference. Mounting the housing on the holder ensures an increased degree of positional accuracy for the temperature sensors and the sleeve. Further adjustments, which may become necessary because the temperature sensors on a pipe are repositioned, are in principle unnecessary in the inventive method. The calibration of the temperature measuring device is consequently reliable and can be implemented precisely.

In one embodiment of the method, the temperature measuring device is designed in accordance with one of the above-disclosed embodiments. The technical advantages of the inventive temperature measuring device are thus also achieved when this is calibrated. In particular, after such calibration with the claimed temperature measuring device, increased measurement accuracy and reduced delay can be achieved when measuring the temperature of the medium in the pipe. The advantage of simple calibration is achieved for the claimed temperature measuring devices in a particularly economical manner. In addition, the temperature sensors are protected by the sleeve against mechanical influences from the environment, meaning that the inventive method can also be performed in the course of maintenance in an automation system. The features of the claimed temperature measuring device can therefore be readily transferred to the method in accordance with the disclosed embodiments.

The objects and advantages in accordance with the invention are furthermore achieved by an computer program product that is established to simulate an operating behavior of a temperature measuring device. The computer program product comprises commands which, when the computer program product is executed by a computer, cause the computer to simulate the operating behavior of the temperature measuring device. The temperature measuring device to be simulated is configured to measure the temperature of a medium in a pipe on which the temperature measuring device is mounted in a mounted state. In accordance with the invention, the temperature measuring device to be simulated is configured in accordance with one the above-described embodiments. For the simulation, the computer program product can have a physics module, in which the temperature measuring device is mapped at least partially. To this end, for example, the temperature measuring device can be emulated in terms of its structural construction and functionality. Alternatively or additionally the temperature measuring device can also be formed as a computing model in the physics module. The physics module is configured, inter alia, to simulate the thermal behavior of the temperature measuring device under adjustable operating conditions. The adjustable operating conditions, for example, include an ambient temperature, a temperature of the medium in the pipe, a thermal conductivity of the medium, of the wall of the pipe, of the sleeve, of the thermal coupling element and/or of the sensor carrier, a flow velocity of the medium and/or a thermal expansion behavior of a component of the temperature measuring device.

The computer program product can have a data interface, via which corresponding data can be specified via a user input and/or other simulation-oriented computer programs. Likewise the computer program product can have a data interface to output simulation results to a user and/or other simulation-oriented computer program products. With the computer program product it is, for example, possible to identify a defective temperature sensor in the temperature measuring device itself and/or a faulty mounting of the temperature measuring device. Furthermore, the temperature measuring device can easily be modeled, i.e., its operating behavior can be recalculated with a minimum of finite element calculations. In particular, only a heat transfer between the wall of the pipe and the sleeve and heat conduction to the first or second temperature sensors must be simulated in order to adjust the functionality of the temperature measuring device. Other heat transfers or heat conduction can be substantially ignored. The inventive computer program product thus allows modeling of the underlying temperature measurement system with a reduced need for computing power. As a result, a plurality of such temperature devices can, for example, be emulated in what is known as an operator station of an automation system. Thus, overall a process image that is especially true to reality can easily be provided. Alternatively or additionally the computer program product can also be executed in an evaluation unit of the temperature measuring device.

The computer program product can be formed as a so-called Digital Twin, as described, for example, in U.S. publication 2017/0286572 A1, the content of which is incorporated by reference herein in its entirety. The computer program product can be established to be monolithic, i.e., executable entirely on one hardware platform. Alternatively the computer program product can be formed to be modular and to comprise a plurality of subprograms that can be executed on separate hardware platforms and to interact via a communicative data connection. Such a communicative data connection can be a network connection or an Internet connection. Furthermore, owing to the inventive computer program product a temperature measuring device can be tested and/or optimized by simulation.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention is explained in greater detail below in figures based on an exemplary embodiment. The figures are to be read as complementary to one another, in that the same reference characters in different figures have the same technical meaning. The features of the form of embodiment can be combined with the features outlined above, in which:

FIG. 1 shows a longitudinally sectioned oblique view of a first embodiment of the temperature measuring device in accordance with the invention;

FIG. 2 shows a longitudinally sectioned detailed view of the first embodiment of the inventive temperature measuring device of FIG. 1;

FIG. 3 shows the first embodiment of the inventive temperature measuring device of FIG. 1 in a disassembled state in a longitudinally sectioned oblique view; and

FIG. 4 is a flowchart of the method in accordance with the invention.

### DETAILED DESCRIPTION OF THE EXEMPLARY EMBODIMENTS

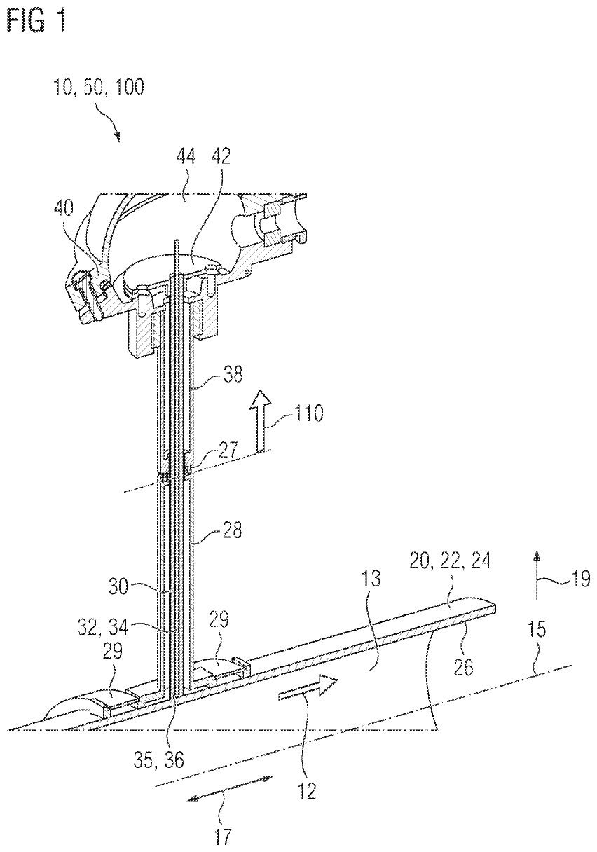

A first embodiment of the temperature measuring device 10 is shown in FIG. 1 in a mounted state in a longitudinally sectioned oblique view. The temperature measuring device 10 is fastened to an outer side 24 of a wall 22 of a pipe 20 via a fastener 29. In the interior of the pipe 20, i.e., on an inner side 26, is a medium 12 that has a temperature 13 that is to be non-invasively measured by the temperature measuring device 10. The medium 12 here flows along a pipe axis 15, via which an axial direction 17 and a radial direction 19 are also defined. The temperature 13 of the medium 12 causes a change in temperature at the wall 22 of the pipe 20, which can be detected via the temperature measuring device 10. The temperature measuring device 10 comprises a holder 28, which extends away from the pipe 20 substantially in a radial direction 19 and is firmly connected to the pipe 20 by the fastener 29. Arranged in the holder 28 is a sleeve 30, in which a first and second temperature sensor 32, 34 are accommodated. The first and second temperature sensor 32, 34 are each formed as resistance thermometers. The sleeve 30 has, at an end facing the pipe 20, a closure 36, via which the temperature sensors 32, 34 are separated from the wall 22 of the pipe 20. A contact region 35 is formed on the closure 36 of the sleeve 30, on which the sleeve 35 touches the wall 22 of the pipe 20 and thus produces a thermally conductive contact. As a result, a heat flow is enabled from the wall 22 of the pipe 20 to the closure 36 of the sleeve 30. This heat flow can be detected by the temperature sensors 32, 34 to determine the temperature 13 of the medium 12.

The sleeve 30 extends in the radial direction 19 beyond the holder 28 into a connecting sleeve 38. The connecting sleeve 38 is coupled via a detachable connection 27 formed as a bayonet lock. The connecting sleeve 38 is firmly connected to a housing 40, in which a measuring transducer connection 42 is arranged. The measuring transducer connection 42 is connected to the sleeve 30 and to the temperature sensors 32, 34 accommodated therein. As a result of the measuring transducer connection 42, the temperature sensors 32, 34 are coupled to a measuring transducer 44 not shown in greater detail. Electrical resistances present in the temperature sensors 32, 34 are measured via the measuring transducer 44 and a temperature value is determined therefrom in each case. The housing 40, in which the measuring transducer connection 42 is accommodated with the measuring transducer 44, can be detached from the holder 28 together with the sleeve 30, by opening the detachable connection 27. The temperature measuring device 10 shown mounted in FIG. 1 represents the initial state and the final state of a method 100 for calibrating the temperature measuring device 10. In a first step 110 of the method 100, the housing 40 is detached from the holder 28 together with the sleeve 30. Furthermore, the temperature measuring device 10 illustrated in FIG. 1 is mapped in a computer program product 50, by which the operating behavior of the temperature measuring device 10 can be simulated. To this end, the computer program product 50 is formed as a so-called Digital Twin.

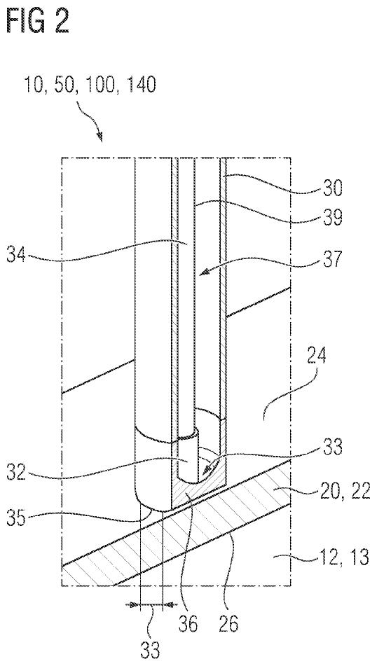

The first embodiment of the temperature measuring device 10 is shown in a longitudinally sectioned detailed view in FIG. 2.

For greater clarity, the holder 28, as shown in FIG. 1, is not depicted in FIG. 2. Arranged in the sleeve 30 is a sensor carrier 39, which is formed substantially rod-shaped, and to which the first and second temperature sensor 32, 34 are attached. The first temperature sensor 32 is positioned radially inside the second temperature sensor 34. Furthermore, owing to the sensor carrier 39 a thermally conducting connection is produced between the first and second temperature sensor 32, 34. The sleeve 30 has, at its end facing the pipe 20, a contact region 35 which, in the mounted state, touches the wall 22 of the pipe 20, and thus produces a thermally conductive connection between the pipe 20 and the sleeve 30. To form the contact region 35, the closure 36 of the sleeve 30 is configured to be flat and convex in sections. In combination with the likewise convex wall 22, the contact region 35 is thereby defined, in which the closure 36 touches the wall 22, and thus couples thermally conductively. Furthermore, the closure 36 has, in the region of the contact surface 35, a section 33 with reduced wall thickness. The section 33 with reduced wall thickness is substantially central on the closure 36, and is thus positioned in the contact region 35. Accordingly, as a result of the reduced wall thickness in the corresponding section 33 and the touching of the wall 22 in the contact region 35 there is a reduced thermal conductivity resistance, as a result of which a defined heat flow from the wall 22 to the sleeve 30 is permitted. The first temperature sensor 32 is arranged such that it is, in turn, in thermally conductive contact with the contact region 35. The heat flow from the wall 22 into the sleeve 38 thus reaches the first temperature sensor 32 and the sensor carrier 39 in a defined manner. The contact region 35 implements the principle of a thermal bridge or thermal window.

A thermal insulator 37, not shown in greater detail, is accommodated in the sleeve 30, and surrounds the sensor carrier 39. As a result of the thermal insulator 37, heat flow between the sensor carrier 39 and the sleeve 30 is minimized. As a result, thermal scatter losses caused by heat flow from the sensor carrier 39 to the sleeve 30 or interference from the environment in the form of heat flows from the sleeve 30 to the sensor carrier 39 are prevented. A heat flow that reaches the first temperature sensor 32 is routed by the sensor carrier 39 substantially loss-free to the second temperature sensor 34. The second temperature sensor 34 is positioned radially outside the first temperature sensor 32 and the thermal conduction properties of the sensor carrier 39 are known. Consequently, the temperature 13 of the medium 12 in the pipe 20 can be determined from temperature measured values of the first and second temperature sensor 32, 34. The installation situation for the sleeve 30 shown in FIG. 2 occurs inter alia if a fourth step 140 of a method 100 for calibrating the temperature measuring device 10 is concluded, i.e., the sleeve 30 is again mounted in the holder 28 (not shown). The temperature measuring device 10 illustrated in FIG. 2 is also mapped in a computer program product 50, which is configured to simulate the operating behavior of the temperature measuring device 10.

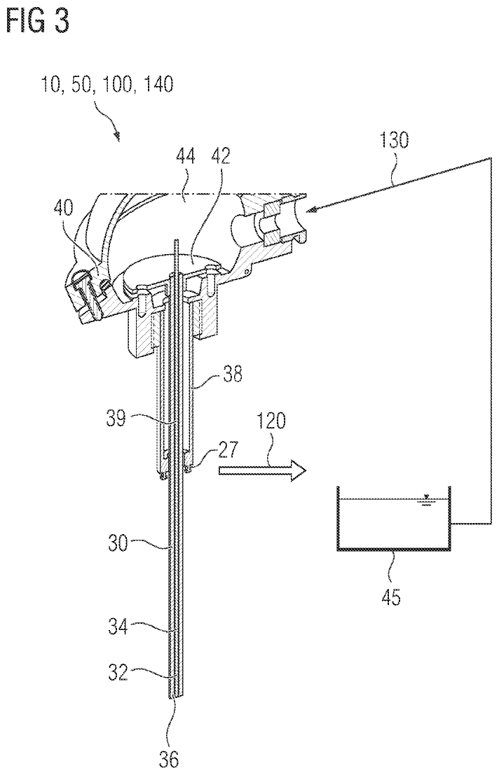

The first embodiment of the temperature measuring device 10 is shown in a disassembled state in FIG. 3. The disassembled state shown in FIG. 3 assumes that the first step 110 of the method 100 for calibrating the temperature measuring device 10, as shown in FIG. 2, has already been performed. The temperature measuring device 10 comprises a housing 40, in which a measuring transducer 44 can be coupled to a measuring transducer connection 42. The housing 40 is firmly connected to a connecting sleeve 38, which at an end applied to the housing 40 is provided with a detachable connection 27. A sleeve 30 in which a first and second temperature sensor 32, 34 are accommodated that are formed as resistance thermometers extends through the connecting sleeve 38. The temperature sensors 32, 34 are arranged on a sensor carrier 39 that is also accommodated in the sleeve 30. At an end of the sleeve 30 facing the pipe 20, and thus applied to the housing 40, the sleeve 30 has a closure 36. The disassembled temperature measuring device 10 in accordance with FIG. 3 is, in a second step 120 of the method 100 for calibrating the temperature measuring device 10, immersed with the sleeve 30 at least partially in a calibration bath 45. Accordingly, a calibration measurement is performed, by which the parameters can be determined, in accordance with which the temperature measuring device 10 can be adjusted. The adjustment of the temperature measuring device 10 as a function of this occurs in a third step 130 of the method 100, for example, by manual or machine-aided input on the measuring transducer 44, not shown in greater detail. The steps 120, 130 outlined can likewise be adjusted by a computer program product 50 and likewise form part of the operating behavior of the temperature measuring device 10.

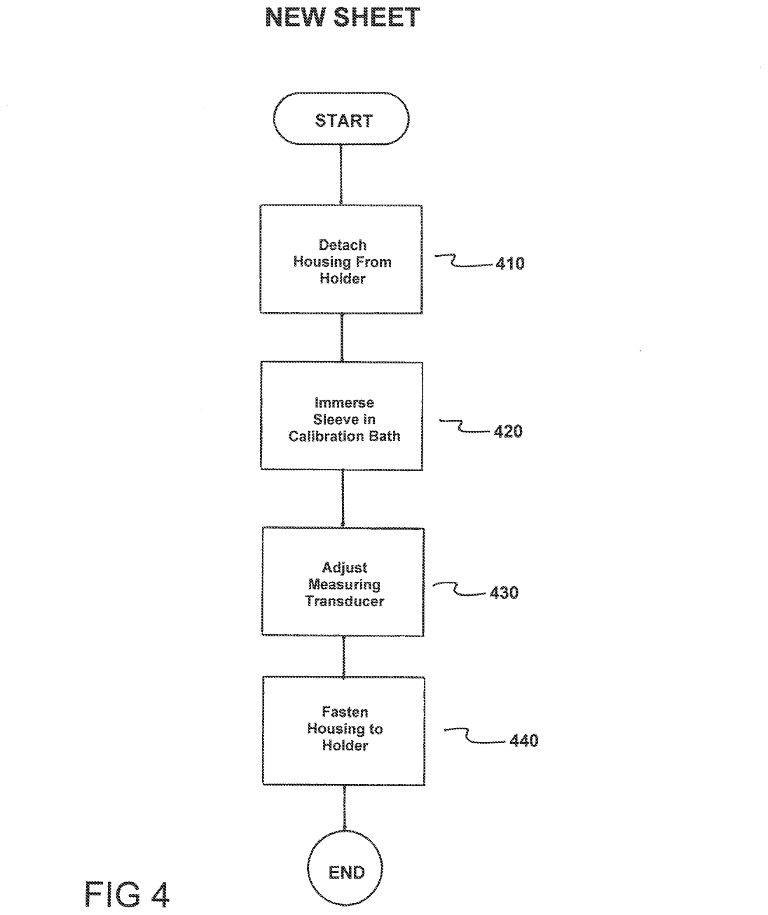

FIG. 4 is a flowchart of the method 100 for calibrating a temperature measuring device 10 for non-invasive temperature measurements in a pipe 2), where the temperature measuring device 10 comprises a housing 40 having a measuring transducer 42, to which a first and second temperature sensor 32, 34 are connected and which are accommodated in a sleeve 30 that is connected to the housing 40. The method comprises a) detaching the housing 40 with the sleeve 30 from a holder 28 protruding substantially radially from the pipe (0, as indicated in step 410.

Next, b) the sleeve 30 is at least partially immersed in a calibration bath 45 and a calibration measurement is performed, as indicated in step 420.

Next, c) the measuring transducer 44 is adjusted as a function of the calibration measurement, as indicated in step 430.

Next, d) the housing 40 with the sleeve 30 is fastened to the holder 28, as indicated in step 440. In accordance with the method, the sleeve 30 includes a closure 36 which, during in step 440 is brought into thermally conductive contact with a wall 22 of the pipe 20.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-13. (canceled)

14. A temperature measuring device for non-invasively measuring a temperature of a medium in a pipe, comprising:
a sleeve having a closure for contacting a wall of the pipe, an outer surface of the closure of the sleeve being configured in a convex manner so as to thermally contact the wall of the pipe;
a first and second temperature sensor, which are accommodated in the sleeve; and
wherein the closure of the sleeve includes a section having a reduced wall thickness for thermal connection of the first temperature sensor to the wall of the pipe, the reduced wall thickness being less than a wall thickness of the sleeve.

15. The temperature measuring device as claimed in claim 14, wherein the convex outer surface is formed as a uniaxially curved outer surface or as a synclastic outer surface.

16. The temperature measuring device as claimed in claim 14, wherein the first temperature sensor contacts the closure of the sleeve in a mounted state.

17. The temperature measuring device as claimed in claim 15, wherein the first temperature sensor contacts the closure of the sleeve in a mounted state.

18. The temperature measuring device as claimed in claim 14, wherein the sleeve is detachably accommodated in a holder protruding substantially radially from the pipe.

19. The temperature measuring device as claimed in claim 14, wherein a thermal insulator for minimizing a heat flow between the first or second temperature sensor and the sleeve is accommodated in the sleeve.

20. The temperature measuring device as claimed in claim 14, wherein the first and second temperature sensor are spaced radially apart and fastened to a sensor carrier.

21. The temperature measuring device as claimed in claim 14, wherein the first and second temperature sensor are arranged radially spaced apart and are thermally conductively connected to one another via a coupler.

22. The temperature measuring device as claimed in claim 20, wherein the first and second temperature sensor are arranged radially spaced apart and are thermally conductively connected to one another via a coupler.

23. The temperature measuring device as claimed in claim 14, wherein the first and second temperature sensor are, at an end facing away from the pipe, firmly connected to a measuring transducer connection.

24. The temperature measuring device as claimed in claim 18, wherein the first and second temperature sensors are, in a section facing away from the pipe, directly or indirectly connected to a housing;
wherein a measuring transducer is arranged in the temperature measuring device; and
wherein the housing is detachably connected to the holder.

25. A method for calibrating a temperature measuring device for a non-invasive temperature measurement in a pipe, the calibrating a temperature measuring device comprising a housing having a measuring transducer, to which a first and second temperature sensor are connected and which are accommodated in a sleeve which is connected to the housing, the method comprising:
a) detaching the housing with the sleeve from a holder protruding substantially radially from the pipe;
b) at least partially immersing the sleeve in a calibration bath and performing a calibration measurement;
c) adjusting the measuring transducer as a function of the calibration measurement; and
d) fastening the housing with the sleeve to the holder;
wherein the sleeve includes a closure which in step d) is brought into thermally conductive contact with a wall of the pipe.

26. A non-transitory computer readable medium encoded with a computer program product for simulating an operating behavior of a temperature measuring device which is mounted on the pipe to measure a temperature of a medium in the pipe, the computer program product comprises commands which, when executed on a computer, causes said computer to simulate the operating behavior of the temperature measuring device, wherein the temperature measuring device is configured in accordance with claim 14.
